(19) United States
(12) Patent Application Publication
(10) Pub. No.: US 2026/0257902 A1
(43) Pub. Date: Sep. 3, 2026

(54) Ram Positioning System for Dent Removal on Substantially Cylindrical Towers and Method for Use

(71) Applicant: P16 Holdings, LLC, Amarillo, TX (US)

(72) Inventors: Todd Perry Bentley, Amarillo, TX (US); Cezar Luquet de Freitas, Jr., Santos-SP (BR)

(21) Appl. No.: 19/528,227

(22) PCT Filed: Aug. 2, 2024
(86) PCT No.: PCT/US2024/040837

§ 371 Date: Apr. 13, 2026

Related U.S. Application Data
(60) Provisional application No. 63/470,214, filed on Jun. 1, 2023.

(51) Int. Cl. B66F 19/00

(52) U.S. Cl. CPC B66F 19/00

(57) ABSTRACT

A ram positioning system for dent removal on turbine towers and a method of use is disclosed. The ram positioning system includes one adjustable beam with a base end and a ram end, and possibly including a support beam. The ram positioning system aligns the ram in place to provide accurate and full dent removal in a wall of a substantially cylindrical turbine tower.

This application claims priority to U.S. Provisional Patent Application No. 63/470,214 filed on Jun. 2, 2023 entitled “Cylindrical Tube Dent Removal System Hydraulic Ram Positioning System,” which is hereby incorporated in its entirety, including any appendixes, as if fully set forth herein.

FIELD The current invention is a ram positioning system for dent removal on a substantially cylindrical tower and method for use.

### BACKGROUND

As technology is changing and renewable energy is becoming more attractive, the generation of wind energy is a growing commodity. To produce this wind energy, large wind farms consisting of high-height wind turbines are being built in multiple locations. The high height wind turbines are transported to the wind farm sites in modular pieces and are erected and bolted together on site. Damage to the towers can occur during the transport to the sites, during the erection process, and after construction in the form of blade strikes from malfunction.

When a tower becomes dented, its structural integrity is compromised, and the tower is at risk of collapse. In many cases, however, the structural integrity of the towers may be restored if the dent can be removed. Dent removal can be performed by using force from inside the tower to push the inside of the dent out to restore its original shape. One way of creating the proper amount of force is by utilizing a hydraulic ram. These hydraulic rams come in various shapes, sizes, and force outputs.

Additionally, it is important to understand the unique size, shape, and depth of each dent in the tower. When repairing a dent, a technician does not want to create a further problem to the structural integrity of the tower, but at the same time, wishes to properly remove the entire dent being corrected. A device and system are needed to accurately, safely, and efficiently remove dents from the towers without causing more damage.

### SUMMARY

The present invention provides a device, systems and methods in which a ram positioning device for dent removal on wind turbine towers and system includes a ram positioning system with an adjustable beam, wherein the beam has a head end and a base end. The base end comprises a curved base, and the head end comprises a ram with a ram head. The curved base may articulate and contacts a first side of an interior wall of a substantially cylindrical tower, and the ram head contacts a dented second side of the interior wall of a substantially cylindrical tower substantially horizontal to the first side of the interior wall of the substantially cylindrical tower. The ram causes force to be affected on to the dented second side of the interior wall of the substantially cylindrical tower to remove the dent.

The present invention is a ram positioning device for dent removal on a substantially cylindrical tower comprising an adjustable beam including a head end and a base end. The base end comprises a curved base having a front side, a back side having a center, a top end, a bottom end, a base first end, and a base second end, and a base attachment means coupled to the back side. There is also a base support coupler having at least one base fastener means, wherein the base support coupler is coupled to the base attachment means. Moreover, the head end comprises a ram having a ram first end and a ram second end. There is also a ram head coupled to the ram first end. Moreover, a ram attachment means has at least one ram fastener means coupled to the ram second end and a ram support coupler. The base end couples to the head end by selecting from the group consisting of directly couples and indirectly couples. The curved base contacts a first side of an interior wall of the substantially cylindrical tower, and the ram head contacts a dented second side of the interior wall of the substantially cylindrical tower substantially horizontal to the first side of the interior wall of the substantially cylindrical tower. The ram causes force to be applied to the dented second side of the interior wall of the substantially cylindrical tower to remove the dent.

It is an object of the invention to provide a ram positioning device for dent removal on an interior wall of a substantially cylindrical tower.

It is a further object of the invention to provide a ram positioning device that is modular for dent removal on an interior wall of a substantially cylindrical tower.

It is a further object of the invention to provide a ram positioning device that includes rigging points.

It is a further object of the invention to provide a ram positioning device that does not cause further damage to the substantially cylindrical tower.

The method, overall operation, and technical characteristics of the present invention will become apparent with the detailed description of preferred embodiments and the illustration of the related drawings herein.

### BRIEF DESCRIPTION OF THE DRAWINGS

FIG. 1 is a perspective of a preferred embodiment of a ram positioning device.

FIG. 2 is a top view of the preferred embodiment of the ram positioning device of FIG. 1.

FIG. 3 is a bottom view of the preferred embodiment of the ram positioning device of FIG. 1.

FIG. 4 is a first side view of the preferred embodiment of the ram positioning device of FIG. 1.

FIG. 5 is a second side view of the preferred embodiment of the ram positioning device of FIG. 1.

FIG. 6 is a first end view of the preferred embodiment of the ram positioning device of FIG. 1 without the ram having a non-marring polymer surface on the front side.

FIG. 7 is a second end view of the preferred embodiment of the ram positioning device of FIG. 1 without the ram head having a non-marring polymer surface.

FIG. 8 is an exploded view of the preferred embodiment of the ram positioning device of FIG. 1.

FIG. 9 is a side perspective view of another preferred embodiment of a ram attachment.

FIG. 10 is a side perspective view of another preferred embodiment of the ram attachment in FIG. 9.

### DETAILED DESCRIPTION

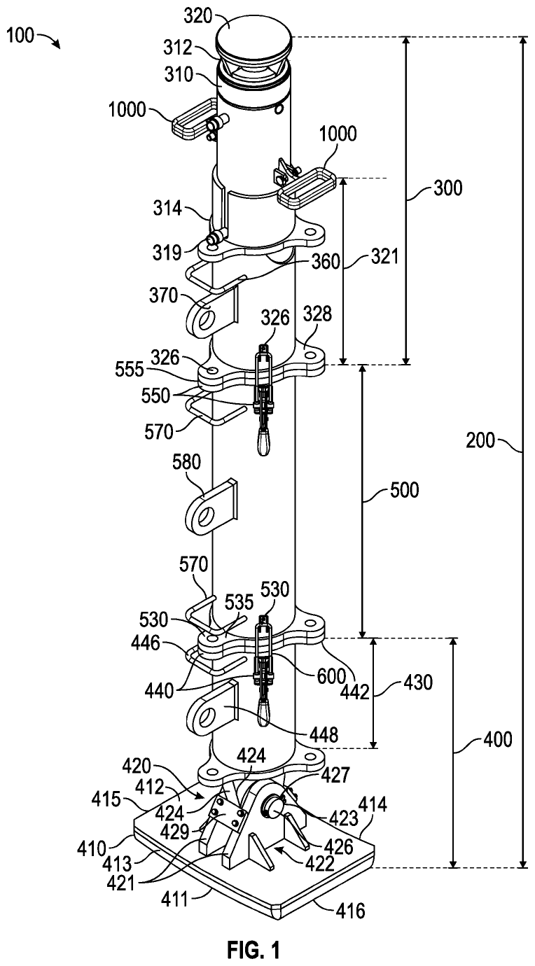

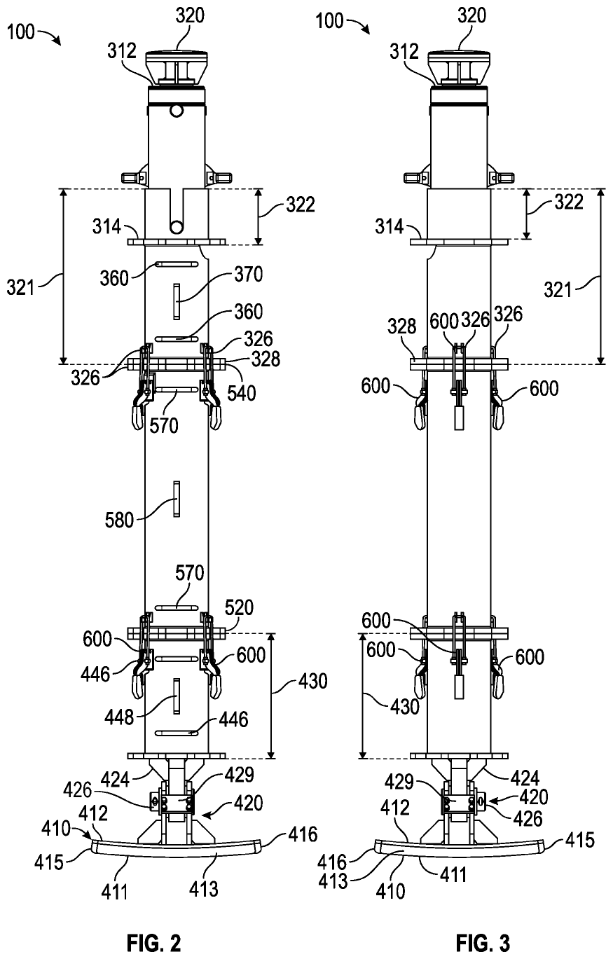

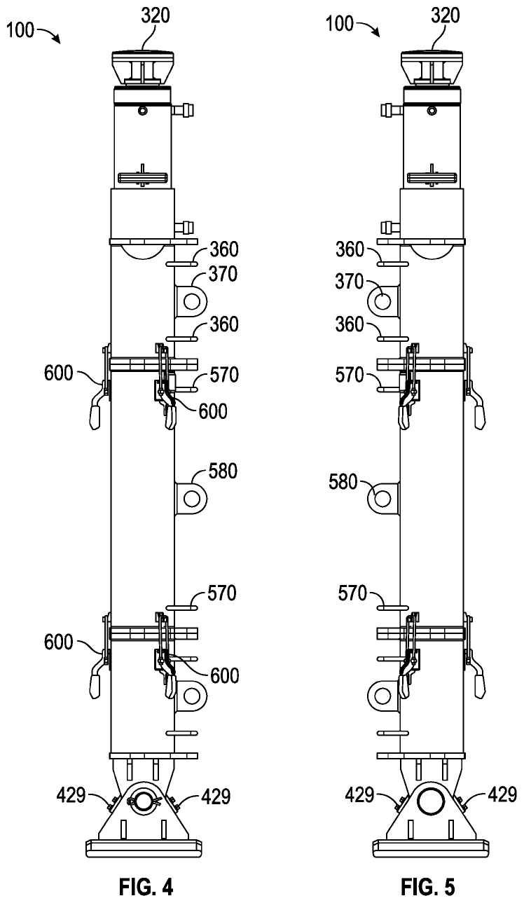

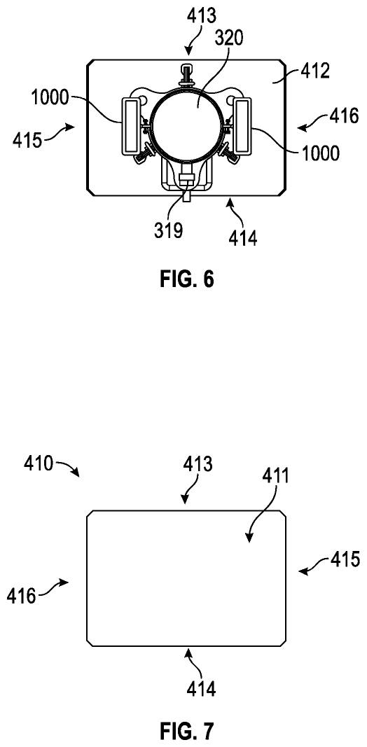

The present invention relates to a ram positioning device and system for dent removal on a substantially cylindrical tower. As seen in FIGS. 1-5 and 8, in one preferred embodiment, the ram positioning device 100 comprises an adjustable beam 200 wherein the adjustable beam 200 includes a head end 300 and a base end 400 and at least one support beam 500. The head end 400 of the adjustable beam 200 comprises a ram 310 with a ram head 320 and a ram attachment means 321.

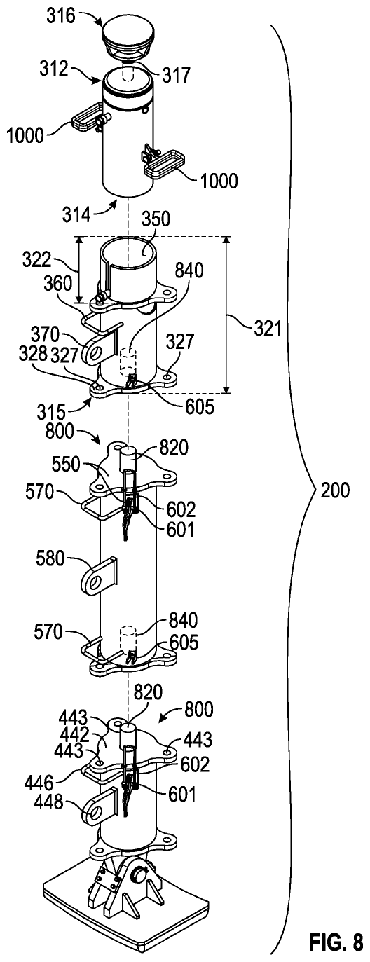

In the preferred embodiment shown in FIGS. 1-5 and 8 the base end 400 includes a curved base 410 having a front side 411, a back side 412 having a center, a top end 413, a bottom end 414, a base first end 415, and a base second end 416; and a base attachment means 420 coupled to the back side 412; and a base support coupler 430 having at least one base fastener means 440. The curved base 410 can be either a convex or concave shape. The base attachment means 420 may be of any type with sufficient strength to allow the adjustable beam 200 to be used for removing a dent from a wall of a substantially cylindrical tower. While the base attachment means 420 may be any type of attachment means to couple the curved base 410 to the base support coupler 430, whether articulating or not, the preferred embodiment shows a hinge 420 comprising a hinge base 422 mountable on the back side 412 of the curved base 410 and having a hinge receptor 421 having at least one receptor hole 423 and a hinge coupler 424 having at least one coupler hole 425 (shown in FIG. 8) and a hinge pin 426 and a cotter pin 427 for coupling the at least one receptor hole 423 of the hinge base 422 to the at least one coupler hole 425 of the hinge coupler 424 using the hinge pin 426 and the cotter pin 427. The hinge coupler 424 is coupled to the base support coupler 430 in this preferred embodiment. As shown in FIG. 1, the base attachment means 420 can articulate and is limited by a hinge articulation limiter 429. In this preferred embodiment, the hinge articulation limiter comprises two limiter plates 429.

In the preferred embodiment, the articulation is in one direction between the top end 413 and bottom end 414 as it is limited by the hinge 420. Moreover, the back side 413 has a center in relation to the midway point between the top end 413 and the bottom end 414 and in relation to the midway point between the base first end 415 and the base second end 416. It is preferable that the base support coupler 430 is limited to articulating up to forty-five degrees (45 degrees) from perpendicular to the center of the back side 412 in either direction. More preferably, the base support coupler 430 may articulate up to twenty degrees (20 degrees) from perpendicular to the center of the back side 412 in either direction. Most preferably, the base support coupler 430 may articulate up to three degrees (3 degrees) from perpendicular to the center of the back side 412 in either direction. In addition, the base attachment means 420 may also be of other types of attachment means to allow more than one degree of articulation in multiple directions such as a ball and socket type attachment means. Again, the base attachment means 420 having more than one degree of articulation in multiple directions can articulate preferably up to 45 degrees, more preferably up to 20 degrees, and most preferably up to 3 degrees from perpendicular to the center of the back side 412 in any allowable articulation direction. This articulation is meant to allow for the changing cylindrical shape of the tower. As the ram positioning device 100 moves along the inside wall of the tower, the shape changes slightly. The articulation allows for the ram positioning device 100 to maintain its substantially horizontal position between the tower walls.

With regard to the base support coupler 430 having at least one base fastener means 440 shown in FIGS. 1-5 and 8, the at least one base fastener means 440 may be of any type so long as the at least one base fastener means 440 is demountable. It is important that the base fastener means 440 is demountable because the modular nature of the ram positioning system 100 allows for accuracy, efficiency, and safety when installing and using the device. In one preferred embodiment, the base support coupler 430 includes a base coupler bed plate 442 as an example of an at least one base support fastener means 440, which is coupled to the base support coupler 430 sufficiently distant from the base attachment means 420 to allow the base end 400 to either directly couple or indirectly couple to the head end 300. The base coupler bed plate 442 preferably includes holes 443, as seen in FIG. 8, that can accommodate fasteners to removably couple to the at least one support beam 500 via a first beam fastening means 530 or directly to the head 300 via a ram fastening means 326. The means of attachment can be screws, bolts, lugs with nuts, or another method.

In an additional preferred embodiment, the base support coupler 430 includes at least one releasable attachment 600 such as a latch clamp 601 or pull action latch clamp. In the embodiment, as shown in the exploded view of FIG. 8, the latch clamp 601 is comprised of two pieces. The first piece is the latch U bar portion 602 and the second piece is the latch plate 605. The latch U bar portion 602 is integral with the base support coupler 430, and the latch plate 605 is integral with the first beam end 520. These latch clamps 601 can be used with or without the use of the base coupler bed plate 442. Moreover, as with the base coupler bed plate 442 configuration, the base end 400 can either directly couple or indirectly couple to the head end 300 using the latch clamps 601. If the base end 400 is directly coupled to the head end 300 the latch U bar portion 602 is integral with the base support coupler 430 and the latch plate 605 is integral with the head end 300. Preferably there are at least two releasable attachments 600 on the base support coupler 430, and more preferably, there are at least three releasable attachments 600 on the base support coupler 430.

Additionally, it is preferred that the base support coupler 430 also includes at least one base support coupler handle 446 and at least one base support coupler rigging point 448. The base support coupler handle 446 allows for the base support coupler 430 to be easily and safely maneuvered by the technicians. This base support coupler handle 446 is preferably an integral part of the base support coupler 430. Moreover, the base support rigging point 448 provides the ability for the base support coupler 430 and attached curved base 410 to be safely and easily used in suspension inside the substantially cylindrical tower. This rigging point 448 is also integral to the base support coupler 430 and provides safety and improved accuracy when using the ram positioning system 100 in suspension.

As shown in FIGS. 1-5 and 8-10, a preferred embodiment of the head end 300 includes a ram 310 having a ram first end 312 and a ram second end 314 and a ram head 320 coupled to the ram first end 312 and a ram attachment means 321 having a ram support coupler 322 and at least one ram fastener means 326. It is preferred that the head end also includes a head first end 315 and a head second end 316. In the preferred embodiment, the ram head 320 is coupled to the ram 310 via screw type fastener 317 as shown in FIG. 8. The attachment could also be by sliding a sleeve over a shaft and putting a pin through it. The ram 310 can be any kind of ram that extends, for example a hydraulic ram or an electric motor ram. Preferably the ram 310 is a dual action hydraulic ram that requires hydraulic fluid to either extend or retract. The ram attachment means 321 couples to the ram second end 314 using a ram support coupler 322. The ram 310 may also include handles 1000 for easy maneuvering and insertion into and removal from the ram support coupler 322. The ram 310 can be coupled to the ram support coupler 322 in any manner that maintains the structural strength of the adjustable beam 200; for example, bolting or screwing the ram 310 to the ram support coupler 322.

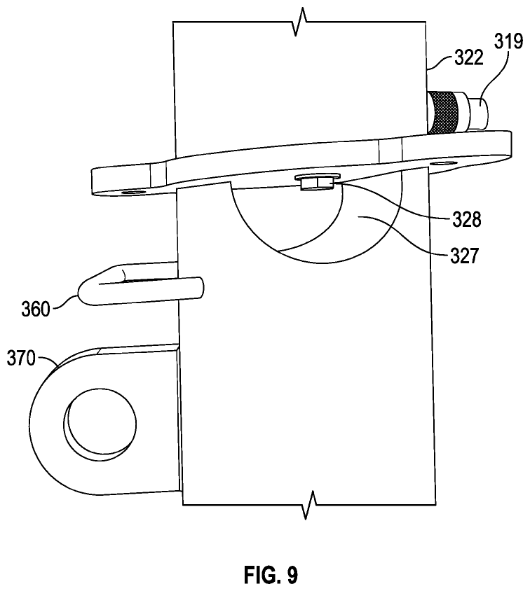

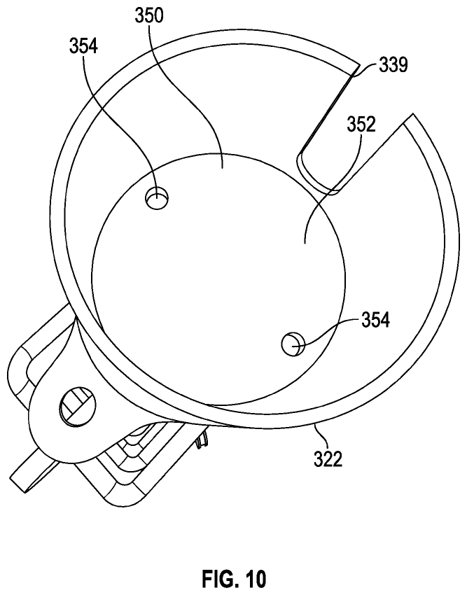

In this preferred embodiment, the ram support coupler 322 couples to the ram second end 314 by coupling to a ram support cavity 350 having internal wall 352 with at least one mounting hole 354 as shown in FIG. 9. Preferably, the ram support cavity 350 includes a slot 339 to accommodate a lower ram hydraulic port 319. More preferably the ram support coupler 322 includes at least one opening 327 to allow bolts 328 or other mounts to secure the ram second end 314 to the internal wall 352 through the at least one mounting hole 354. This method of securing the ram 310 is preferred because it allows for the ram 310 to be easily changed and/or maintained.

With regard to the ram attachment means 321 shown in FIGS. 1-5 having a ram support coupler 322 and at least one ram fastener means 326, the at least one ram fastener means 326 may be of any type of fastener so long as the at least one ram 9 fastener means 326 is demountable. It is important that the ram fastener means 326 is demountable because, as stated above, the modular nature of the ram positioning system 100 allows for accuracy, efficiency, and safety when installing and using the device. In one preferred embodiment, the ram support coupler 322 includes a ram coupler bed plate 328 as an example of an at least one ram support fastener means 326 and is sufficiently displaced from the ram coupler 322 to allow the head end 300 to either directly couple or indirectly couple to the base end 400. The ram coupler bed plate 328 preferably includes holes 327, as seen in FIG. 8, that can accommodate fasteners to removably couple to the at least one support beam 500 via a second beam fastening means 550 or directly to the base end 400 via a ram fastening means 326. The means of attachment can be screws, bolts, lug with nuts, or another method.

In addition, it is preferred that the ram fastener means 326 includes at least one releasable attachment 600 such as a latch clamp 601 or pull action latch clamp. In the embodiment, as shown in the exploded view of FIG. 8, the latch clamp 601 is comprised of two pieces. The first piece is the latch U bar portion 602, and the second piece is the latch plate 605. The latch U bar portion 602 is integral with the second beam end 540 and the latch plate 605 is integral with a first head end 315. These latch clamps 601 can be used with or without the use of the ram coupler bed plate 328. Moreover, as with the ram coupler bed plate 328 configuration, the base end 400 can either directly couple or indirectly couple to the head end 300 using the latch clamps 601. If the base end 400 is directly coupled to the head end 300 the latch U bar portion 602 is integral with the base support coupler 430 and the latch plate 605 is integral with the head end 300. Preferably there are at least two releasable attachments 600, and more preferably, there are at least three releasable attachments 600. Preferably there are at least two releasable attachments 600 on the ram attachment means 321, and more preferably, there are at least three releasable attachments 600 on the ram attachment means 321.

Additionally, it is preferred that the ram attachment means 321 includes at least one ram attachment handle 360 and at least one ram attachment rigging point 370. The ram attachment handle 360 allows for the ram attachment means 321 to be easily and safely maneuvered by the technicians. This ram attachment handle 360 is preferably an integral part of the ram attachment means 321. Moreover, the ram attachment rigging point 370 provides the ability for the ram attachment means 321 to be safely and easily used in suspension inside the substantially cylindrical tower. This rigging point 370 is also integral to the ram attachment means 321 and provides safety and improved accuracy when using the ram positioning system 100.

In the preferred embodiment of FIGS. 1-5 and 8, the adjustable beam 200 further includes at least one support beam 500 having a first beam end 520 and a second beam end 540, and at least one first beam fastener means 530 on the first end 520 and at least one second beam fastener means 550 on the second end 540 so that the base end 400 couples to the first beam end 520 of the at least one support beam 500 and the head end 300 couples to the second beam end 540 of the at least one support beam 500 so that the base end 400 indirectly couples to the head end 300 using the at least one support beam 500. The at least one first beam fastener means 530 and the at least one second beam fastener means 550 may be of any type so long as the at least one first beam fastener means 530 and the at least one second beam fastener means 550 are demountable. It is important that these fastener means 530 and 550 are demountable because, as stated above, the modular nature of the ram positioning system 100 allows for accuracy, efficiency, and safety when installing and using the device. In one preferred embodiment, the at least one support beam 500 includes a first support beam bed plate 535 as an example of the at least one first beam fastener means 530 and a second support beam bed plate 555 as an example the of at least one second beam fastener means 550.

In one embodiment, the first support beam bed plate 535 may be coupled to the base coupler bed plate 442 and the second support beam bed plate 555 may be coupled to the ram coupler bed plate 328. Additionally, it is preferred that the at least one support beam 500 includes at least one releasable attachment 600 such as a latch clamp 601 or pull action latch clamp. Preferably, there are at least two releasable attachments 600 on each of the first beam end 520 and the second beam end 540 and more preferably, there are at least three releasable attachments 600 on each of the first beam end 520 and the second beam end 540.

Preferably, the at least one support beam 500 also includes at least one support beam handle 570 and at least one support beam rigging point 580. The at least one support beam handle 570 allows for the at least one support beam 500 to be easily and safely maneuvered by the technicians. This at least one support beam handle 570 is preferably an integral part of the at least one support beam 500. Moreover, the at least one support beam rigging point 580 provides the ability for the at least one support beam 500 to be safely and easily used in suspension inside the substantially cylindrical tower. This rigging point 580 is also integral to the at least one support beam 500 and provides safety and improved accuracy when using the ram positioning system 100.

More preferably, each of the base end 400, the head end 300, and the at least one support beam 500 include an alignment mechanism 800 as shown in FIG. 8. In one preferred embodiment, the alignment mechanism is a fixed rod 820 and a hole 840 that are matingly matched on each respective end of the base end 400, the head end 300, and the at least one support beam 500. This preferred configuration ensures that each modular piece of the adjustable beam 200 may be easily aligned and fastened to each other.

In another alternate embodiment, more than one support beam 500 can be inserted into the ram positioning system 100. These support beams 500 can be of various lengths. This allows the ram position system 100 to change with the variation of the diameter of the interior tower wall. This reduces the number of support beams 500 that may need to be transported to any job site.

More preferably, the ram head 320 includes a non-marring polymer 900 and the front side 415 of base 410 includes a non-marring polymer 900. Examples of non-marring polymers include high density polyethylene, low density polyethylene, rubber, polytetrafluoroethylene, or any similar compound. The non-marring polymer ensures that the portions of the ram head 320 and front side 415 of the base 410 that come in contact with the interior walls of the turbine tower do not scratch or otherwise damage it.

In one preferred embodiment for a method for removing a dent from a wall of a hollow, substantially cylindrical tower, the method includes the steps of evaluating the dent, formulating a plan for removal of the dent, and placing a ram positioning device against the dent. The ram positioning device being self-aligning and remotely actuatable and includes an adjustable beam including a head end and a base end. The base end comprises a curved base having a front side, a back side having a center, a top end, a bottom end, a base first end, and a base second end, and a base attachment means coupled to the back side, and a base support coupler having at least one base fastener means wherein the base support coupler is coupled to the base attachment means. The head end comprises a ram having a ram first end and a ram second end, and a ram head is coupled to the ram first end. Additionally, a ram attachment means has at least one ram fastener means coupled to the ram second end and a ram support coupler. The base end couples to the head end by selecting from the group consisting of directly couples and indirectly couples. Aligning said ram positioning device substantially along an interior diameter of the hollow substantially cylindrical tower so that the ram head is in contact with one end of the dent and the curved base is in contact with the wall interior wall of the hollow substantially cylindrical tower substantially opposite from the dent. Actuating the ram to cause force to be placed on the dent by the ram head. Moving the ram positioning device along the dent from one end to the other and repeating the forgoing procedure until the dent has been removed from the hollow substantially cylindrical tower, wherein the step of evaluating the dent includes determining a direction of the dent, a size of the dent, a depth of the dent, and a type of damage to the wall where the dent is located.

In another preferred embodiment for a method for removing a dent from a wall of a hollow substantially cylindrical tower, includes the steps of measuring the size of the dent, formulating a plan for removal of the dent, placing a ram positioning device against the dent, the ram positioning device being self-aligning and remotely actuatable and including an adjustable beam including a head end and a base end. The base end 14 comprises a curved base having a front side, a back side having a center, a top end, a bottom end, a base first end, and a base second end. There is a base attachment means coupled to the back side and a base support coupler having at least one base fastener means wherein the base support coupler is coupled to the base attachment means. The head end comprises a ram having a ram first end and a ram second end, a ram head coupled to the ram first end, and a ram attachment means having at least one ram fastener means coupled to the ram second end and a ram support coupler. The base end couples to the head end by selecting from the group consisting of directly couples and indirectly couples. Aligning said ram positioning device substantially along an interior diameter of the hollow substantially cylindrical tower so that the ram head is in contact with one end of the dent and the curved base is in contact with the wall interior wall of the hollow substantially cylindrical tower substantially opposite from the dent. Actuating the ram to cause force to be placed on the dent by the ram head. Moving the ram positioning device along the dent from one end to the other and repeating the forgoing procedure until the dent has been removed from the hollow substantially cylindrical tower, wherein the dent is measured during the dent removal process while a condition of the dent is monitored using one or more non-destructive metal evaluation techniques being selected from a group including surface magnetic particles, ultrasonic testing, electromagnetic wave testing, and strain gauges. More preferably, the plan for removal of the dent is adjusted following each measurement of the dent after each application of force against the dent.

Moreover, it is preferred that these elements are modular in that they can be easily attached and detached from each other in order to make repairs and configuration changes easy and efficient. The modular design of the ram positioning device also allows for easy transport and set up at the work site.

What is claimed is:

1. A ram positioning device for dent removal on a substantially cylindrical tower comprising:
an adjustable beam including a head end and a base end; and
wherein the base end comprises:
a curved base having a front side, a back side having a center, a top end, a bottom end, a base first end, and a base second end;
and
a base attachment means coupled to the back side;
and a base support coupler having at least one base fastener means wherein the base support coupler is coupled to the base attachment means,
and
wherein the head end comprises:
a ram having a ram first end and a ram second end;
and
a ram head coupled to the ram first end;
and
a ram attachment means having at least one ram fastener means coupled to the ram second end and having a ram support coupler;
wherein the base end couples to the head end by selecting from the group consisting of directly couples and indirectly couples; and
wherein the curved base contacts a first side of an interior wall of the substantially cylindrical tower, and the ram head contacts a dented second side of the interior wall of the substantially cylindrical tower substantially horizontal to the first side of the interior wall of the substantially cylindrical tower; and
wherein the ram causes force to be applied to the dented second side of the interior wall of the substantially cylindrical tower to remove the dent.

2. The ram positioning device of claim 1 wherein the base end directly couples to the head end.

3. The ram positioning device of claim 1 wherein the adjustable beam further comprises:
At least one support beam having a first beam end and a second beam end; and
at least one first beam fastener means on the first beam end and at least one second beam fastener means on the second beam end,
wherein the base end couples to the first beam end of the at least one support beam and the head end couples to the second beam end of the at least one support beam so that the base end indirectly couples to the head end using the at least one support beam.

4. The ram positioning device of claim 3 wherein the adjustable beam comprises at least two support beams that are coupled together.

5. The ram positioning device of claim 4 wherein each of the at least two beams comprise a first beam having at least one first beam coupling bed plate and a second beam having at least one second beam coupling bed plate wherein the at least one first beam coupling bed plate is coupled to the at least one second beam coupling bed plate.

6. The ram positioning device of claim 5 wherein the first and second beams are coupled together with fasteners.

7. The ram positioning device of claim 4 wherein the at least two beams are coupled together with at least one releasable attachment;

8. The ram positioning device of claim 1 wherein the adjustable beam comprises at least one rigging point.

9. The ram positioning device of claim 8 wherein the base end comprises at least one rigging point, and the head end comprises at least one rigging point.

10. The ram positioning device of claim 3 wherein the adjustable beam comprises at least one rigging point.

11. The ram positioning device of claim 10 wherein the base end comprises at least one rigging point, and the head end comprises at least one rigging point, and the at least one support beam comprises at least one rigging point.

12. The ram positioning device of claim 1 wherein the adjustable beam comprises at least one handle.

13. The ram positioning device of claim 3 wherein the adjustable beam comprises at least one handle 14. The ram positioning device of claim 1 wherein the curved base is a substantially convex shape.

15. The ram positioning device of claim 1 wherein the curved base further comprises a non-marring polymer surface on the front side.

16. The ram positioning device of claim 1 wherein the curved base comprises a single axis of articulation between the top end and the bottom end.

17. The ram positioning device of claim 1 wherein the ram head further comprises a non-marring polymer surface.

18. The ram positioning device of claim 1 wherein the base end comprises at least one handle and the head end comprises at least one handle.

19. The ram positioning device of claim 3 wherein the adjustable beam comprises at least one handle.

20. The ram positioning device of claim 19 wherein the base end comprises at least one handle and the head end comprises at least one handle and the at least one support beam comprises at least one handle.

21. The ram positioning device of claim 1 wherein the base end attachment means may articulate from perpendicular to the center.

22. The ram positioning device of claim 21 wherein the base end attachment means may articulate from perpendicular to the center is limited to forty five degrees.

23. The ram positioning device of claim 21 wherein the base end attachment means may articulate from perpendicular to the center is limited to twenty degrees.

24. The ram positioning device of claim 21 wherein the base end attachment means may articulate from perpendicular to the center is limited to three degrees.

25. The ram positioning device of claim 3 wherein the base end attachment means may articulate from perpendicular to the center.

26. The ram positioning device of claim 25 wherein the base end attachment means may articulate from perpendicular to the center is limited to forty five degrees.

27. The ram positioning device of claim 25 wherein the base end attachment means may articulate from perpendicular to the center is limited to twenty degrees.

28. The ram positioning device of claim 25 wherein the base end attachment means may articulate from perpendicular to the center is limited to three degrees.

29. The ram positioning device of claim 3 wherein the at least first beam fastener means, the at least second beam fastener means, the at least one ram fastener means, and at least one base fastener means are each at least one bed plate.

30. The ram positioning device of claim 3 wherein the at least first beam fastener means, the at least second beam fastener means, the at least one ram fastener means, and at least one base fastener means are each at least one releasable attachment.
